(19) United States
(12) Patent Application Publication
(10) Pub. No.: US 2013/0054441 A1
(43) Pub. Date: Feb. 28, 2013

(54) METHODS AND SYSTEMS FOR TRADING IN MONETARY EQUIVALENT INSTRUMENTS

(71) Applicant: Bhavik Kamdar, Chicago, IL (US)

(72) Inventor: Bhavik Kamdar, Chicago, IL (US)

(21) Appl. No.: 13/591,478

(22) Filed: Aug. 22, 2012

Related U.S. Application Data
(60) Provisional application No. 61/526,422, filed on Aug. 23, 2011.

(51) Int. Cl. G06Q 40/04

(52) U.S. Cl. 705/37

(57) ABSTRACT

An example method comprises receiving a request to sell a closed loop monetary equivalent instrument for a purchase value, validating the monetary instrument and a balance associated with the monetary equivalent instrument, selectively paying the seller the purchase value, requesting the issuing party or a third party acting on behalf of the issuing party to provide an additional value to be associated with the monetary equivalent instrument, offering the monetary equivalent instrument and the additional value for sale to a buyer for a selling value, receiving a request from the buyer to purchase the monetary equivalent instrument and the additional value combined for the selling value, selling the monetary equivalent instrument and the additional value to the buyer for the selling value, and compensating the issuing party or the third party acting on behalf of the issuing party for providing the additional value.

### CROSS-REFERENCE TO RELATED APPLICATIONS

This application claims priority of U.S. Provisional Application No. 61/526,422, entitled “METHODS AND SYSTEMS FOR TRADING IN MONETARY EQUIVALENT INSTRUMENTS,” filed Aug. 23, 2011, which is incorporated herein by reference in its entirety for all purposes.

### TECHNICAL FIELD

This disclosure relates generally to data processing, and specifically to methods and systems for trading in monetary equivalent instruments.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

A gift card is an example of a restricted monetary equivalent instrument that is issued, for example, by retailers, banks, or restaurants to be used as an alternative to a monetary gift. Gift cards may include open or closed loop monetary equivalent instruments. Gift cards are highly popular because the recipient of the gift card may use it at his or her discretion within the restrictions set by the issuing party. Traditional gift cards are made of plastic but the idea may be easily extended to virtual gift cards. Virtual gift cards may be delivered electronically (e.g., via e-mail or mobile) to their recipient, with the benefits being that they cannot be lost and that the consumer does not have to drive to the bricks and mortar location to purchase a gift card.

Third party brokers may provide gift card brokering services that allow customers to buy or sell their pre-owned gift cards. Buyers would typically buy these pre-owned gift cards anywhere from 3-30% off while sellers would sell their pre-owned gift cards for 50-80% of their face value. For example, a third party broker may buy a Best Buy gift card worth $100 for $80 from a seller and resell the card to a buyer for $90, thereby making under a $10 profit after mailing and other expenses. This approach typically allows the seller to receive 50 to 80 percent of the cards' value.

Most of the existing solutions dealing with conventional plastic gift cards require the seller to mail the card to the third party broker. Once the card is received, the broker would have to validate the card with the issuing party and, if the validation is successful, mail the card to the buyer, thereby making the whole process lengthy and inconvenient.

A few third party brokers provide instant transactions, in which sellers may sell their gift cards electronically. The seller of the gift card may enter the redemption code and the pin number of the gift card online and get an instant offer from the third party broker. No mailing is needed, and the buyer gets the code electronically after the transaction is finalized. These approaches, though offering the issuing party some incentive for participation in the process, do not provide for the possibility of adding value to the gift card before it is resold.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with various embodiments and the corresponding disclosure thereof, a computer-implemented method for trading in monetary equivalent instruments comprises offering to a seller to purchase a monetary equivalent instrument for a purchase amount, with the purchase amount being less than a balance associated with the monetary equivalent instrument. The method further comprises, in response to the offering, receiving, from the seller, a request to sell the monetary equivalent instrument, validating the monetary instrument and the balance with the issuing party, and based on the validation, selectively paying the seller the purchase amount. The method further comprises requesting that the issuing party provide an additional value to be associated with the monetary equivalent instrument, and offering the monetary equivalent instrument and the additional value for sale to a buyer for a selling amount, with the selling amount being smaller than the balance and the additional value combined. The method further comprises, in response to the offering, receiving a request from the buyer to purchase the monetary equivalent instrument and the additional value combined for the selling value, selling the monetary equivalent instrument and the additional value to the buyer for the selling value, and compensating the issuing party for providing the additional value.

The compensation of the issuing party may be reflected by a face value of the additional value or less than the face value after broker fees are subtracted. The monetary equivalent instrument may include a gift card, a voucher, a prepaid card, a credit card, or any stored-value card. The monetary equivalent instrument and the additional value may be provided to the buyer electronically or by mail. The seller may provide a redemption code and a pin number of the monetary equivalent instrument in order to verify the balance. The seller may also verify the balance using his phone ID.

According to one example embodiment, the additional value may be provided by increasing the balance of the monetary equivalent instrument before the monetary equivalent instrument is sold to the buyer. According to another embodiment, the additional value may be provided by deactivating the monetary equivalent instrument and issuing a new monetary equivalent instrument having a higher redemption value than the initial monetary equivalent. According to a further embodiment, the additional value may be provided by packaging the monetary equivalent instrument with a further monetary equivalent. According to a further embodiment, the additional value may be provided by splitting the monetary equivalent instrument into two or more new monetary equivalent instruments and increasing the balances of the new monetary equivalent instruments before they are sold to the buyer.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 shows a block diagram illustrating a system environment suitable for trading in monetary equivalent instruments, according to an example embodiment.

FIG. 2 is a diagram of a trading system, according to an example embodiment.

FIG. 3 is a process flow diagram showing a method for trading in monetary equivalent instruments, according to an example embodiment.

FIG. 4 is a process flow diagram showing a method for trading in monetary equivalent instruments, wherein an additional value provided by an issuing party includes increasing a value of an existing monetary equivalent instrument before it is resold to a buyer, according to another example embodiment.

FIG. 5 is a process flow diagram showing a method for trading in monetary equivalent instruments, wherein an additional value provided by an issuing party includes deactivating an original monetary equivalent instrument and reissuing a new monetary equivalent instrument having a higher redemption value, according to another example embodiment.

FIG. 6 is a process flow diagram showing a method for trading in monetary equivalent instruments, wherein an additional value provided by an issuing party includes packaging an existing monetary equivalent instrument with other monetary equivalent instruments and selling the package, according to another example embodiment.

FIG. 7 is a process flow diagram showing a method for trading in monetary equivalent instruments, wherein an additional value provided by an issuing party includes splitting an existing monetary equivalent instrument into two or more new monetary equivalent instruments and increasing balances of the new monetary equivalent instruments before they are sold to a buyer, according to another example embodiment.

FIG. 8 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

The embodiments described herein may be implemented by various means, depending on application. For example, the embodiments may be implemented in hardware, firmware, software, or a combination thereof. For hardware implementation, the embodiments may be implemented with processors, controllers, micro-controllers, microprocessors, electronic devices, other electronic units designed to perform the functions described herein, or a combination thereof. Memory may be implemented within a processor or external to the processor. As used herein, the term “memory” refers to any type of long term, short term, volatile, nonvolatile, or other storage device and is not to be limited to any particular type of memory or number of memories, or type of media upon which memory is stored. For firmware and/or software implementation, the embodiments may be implemented with modules such as procedures, functions, and so on, that perform the functions described herein. Any machine-readable medium tangibly embodying instructions may be used in implementing the embodiments described herein.

The embodiments disclosed herein relate to methods and systems for trading in monetary equivalent instruments (open or closed loop) that may allow incentivizing an issuing party to participate in the process of reselling monetary equivalent instruments, such as, for example, gift cards (unused or partially used), vouchers, prepaid cards, store credit cards, stored-value cards, mobile wallets, and so forth.

In contrast to the existing solutions, methods and systems for trading in monetary equivalent instruments encourage participation by the issuing party by providing an incentive. This incentive includes allowing the issuing party to sell additional open or closed loop monetary equivalents.

It will be understood that the issuing party may not provide additional open or closed loop equivalent instruments directly. Instead, the additional value may be added by a third party acting on behalf of the issuing party. An example of such party that facilitates the trade acting on behalf of the issuing party is a gift card exchange service.

In one example embodiment, the issuing party may sell the additional monetary equivalents by increasing the value of the existing monetary equivalent instrument before it is resold to the buyer. For example, the value of a $50 gift card being purchased from a seller for $40 may be increased to $100 before it is sold to a buyer for $90. The value may be increased by adding additional funds to the gift card by the issuing party. Thus, the issuing party benefits by being able to sell $50 in additional monetary equivalents.

In another example embodiment, the issuing party may deactivate the original monetary equivalent instrument and reissue a new instrument having a higher redemption value. A reissued monetary equivalent instrument may have a new redemption code. For example, a $50 gift card may be deactivated and a new $100 gift card issued. Similarly, the issuing party benefits from being able to sell $50 in additional monetary equivalents. The resale value of the gift card may be set to $90 by the issuing party. Additionally, there may be some instances, where the issuing party does not deactivate the gift card, rather recycles it for further use and sell or give to another user.

According to one example embodiment, the issuing party may add value to its own gift card and resell it.

In yet another example, the issuing party may package the existing monetary equivalent instruments with other monetary equivalent instruments and sell the package. For example, an existing $50 gift card may be combined with a newly issued $50 gift card. Again, the issuing party may benefit from being able to sell $50 in additional monetary equivalents. The resale value of the combination may be set to $90. Thus, the value of a $50 gift card being purchased from a seller for $40 may be increased to $100 before it is sold to a buyer for $90 by packaging it with another $50 instrument.

In yet another embodiment, the issuing party may exchange one gift card for another. For example, a buyer may make a request to trade a $100 Store A gift card for an $80 Store B gift card. If, for example, a seller willing to sell a $50 Store B gift card for $40 is found, $30 are added to the $50 Store B gift card to create a $80 Store B gift card to be exchanged for the $100 Store A gift card. As a result, the seller receives $40, the issuing party receives a $100 Store A card for $70 value expensed out ($40 purchase paid to the seller for Store B Gift Card and $30 extra in adding value), and the buyer receives $80 Store B Card. The methods and systems described herein may be used in a number of areas, such as an online e-commerce, mobile applications, such as a mobile wallet, and conventional brick and mortar stores.

The methods and systems described herein may be facilitated by any type of radio communication or transfer. In some embodiments, the Near Field Communication (NFC) or any other type of radio communication technology may be used to allow for simplified transactions, data exchange, and connections with a touch. This technology may also allow buyers and seller to make payments by using mobile devices.

The term “closed loop monetary equivalent instrument” relates to a monetary equivalent instrument associated with one or more of a gift card, a code, a voucher, a prepaid card, a stored-value card, and so forth, which may be issued by specific merchants. The closed loop monetary equivalent instruments may be redeemed by the issuing party.

One particular example of the “closed loop monetary equivalent instrument” is a “hybrid closed loop monetary equivalent instrument” (e.g., a gift card for a mall), which may be redeemed in the network of certain affiliated merchants.

The term “open loop monetary equivalent instrument” relates to a monetary equivalent instrument associated with one or more of a prepaid card, a stored-value card, and a credit card, which may be issued by a specific financial institution (e.g., a bank). The open loop monetary equivalent instruments may be redeemed by multiple establishments.

Further, the term “monetary equivalent instrument,” as used herein, relates to one or more of an open loop monetary equivalent instrument, a closed loop monetary equivalent instrument, and a hybrid closed loop monetary equivalent instrument.

The term “issuing party,” as used herein, relates to a retailer, a merchant, a financial institution, and a credit card company and so forth, which may issue a monetary equivalent instrument in the form of a gift card, a code, a voucher, a prepaid card, a stored-value card, a credit card, and so forth.

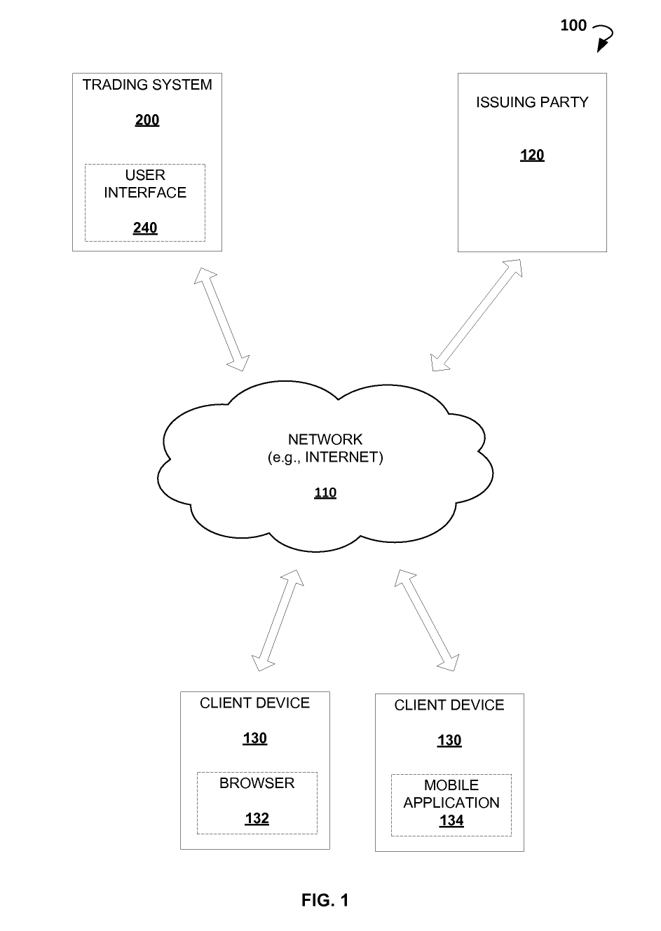

Referring now to the drawings, FIG. 1 shows a block diagram illustrating a system environment 100 suitable for trading in monetary equivalent instruments. As shown in FIG. 1, the system environment 100 may include a network 110, an issuing party 120, a client device 130, and a trading system 200. The network 110 is a network of data processing nodes interconnected for the purpose of data communication, which may be utilized to communicatively couple various components of the environment 100. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network, and so forth. The network 110 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking, and so forth.

The client device 130 may refer to a computer, a laptop, a tablet computer, a portable computing device, a personal digital assistant (PDA), a handheld cellular phone, a mobile phone, a smart phone, a wireless telephone, a handheld device having wireless connection capability, or any electronic device with the ability to receive and transmit data via a wire or wireless network (e.g., with the ability to browse the Internet), or any other type of network. The client device 130 may also be configured to determine its geographical location based on GPS signals, IP addresses, base station information, and so forth.

The client device 130 may be used to communicate with the trading system 200 and to establish and manage a profile of the user associated with the client device 130. For this purpose, the user may utilize a browser 132 of the client device 130, and the trading system may include a user interface 240 accessible via the browser 132. The browser 132 may provide the ability to browse and interact with websites on the Internet, including the website deployed within the trading system 200.

In some other embodiments, the client device 130 may comprise software applications to communicate with the trading system 200. In one example, the software application is a mobile application 134 embedded in the client device 130. In one example, the software application is a social application, such as Facebook Promotions, Storefront Social, Friendgiftr, Shopycat, and so forth.

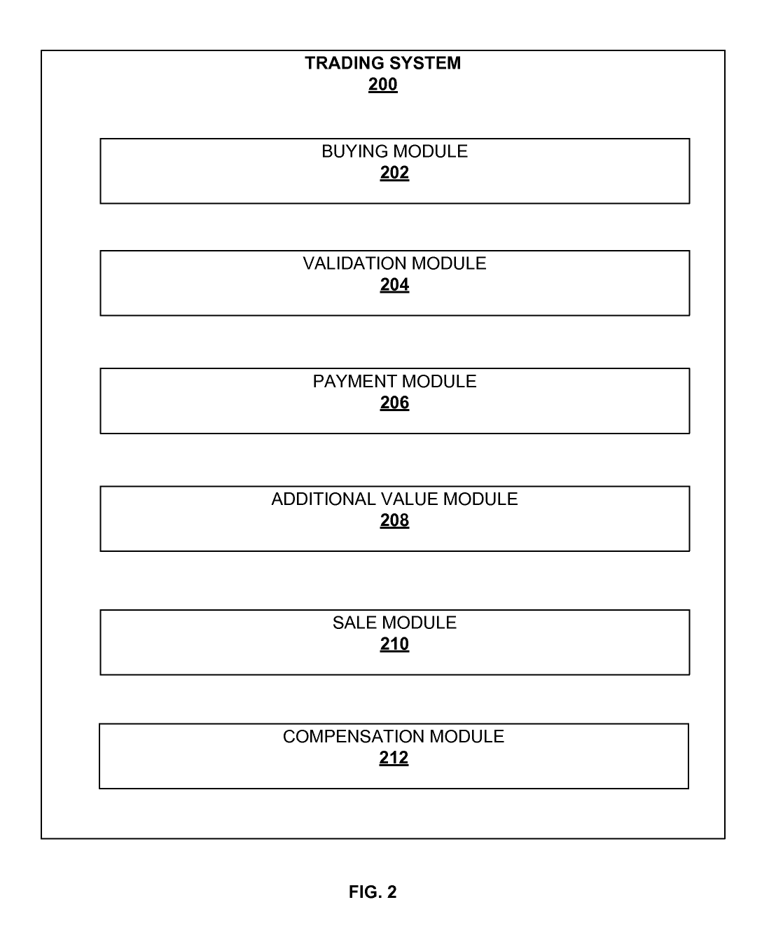

The trading system 200, according to various embodiments disclosed herein, may be configured to allow trading in monetary equivalents. The trading system 200 may be implemented as a server having multiple modules and databases. The trading system 200 is described in more detail below with reference to FIG. 2.

FIG. 2 is a diagram of the trading system 200, according to an example embodiment. In this embodiment, the trading system 200 may include a buying module 202, a validation module 204, a payment module 206, an additional value module 208, and a sale module 210, and a compensation module 212 (optional).

The buying module 202 may be configured to offer to a seller to purchase a monetary equivalent instrument for a purchase value. The purchase value may be less than a balance associated with the monetary equivalent instrument. In one example embodiment, the purchase value may equal or be greater than a balance associated with the monetary equivalent instrument. The buying module 202 may receive, from the seller, a request to sell the monetary equivalent instrument in response to the offer.

The validation module 204 may be configured to validate the monetary instrument and a balance associated with the monetary equivalent instrument with the issuing party.

The payment module 206 may be configured to selectively pay the seller the purchase value. The seller may be paid by a monetary equivalent instrument, currency, or any other types of payments, even by gift card/cards.

The additional value module 208 may be configured to request the issuing party to provide an additional value to be associated with the monetary equivalent instrument. The additional value may be provided in the form of reward points, airline miles, credits, virtual currency (for example, social media points), coupons, or any other types of value-adding methods.

The sale module 210 may be configured to offer the monetary equivalent instrument and the additional value for sale to a buyer for a selling value. The selling value may be smaller than the balance and the additional value combined. The sale module 210 may be further configured to receive a request from the buyer to purchase the monetary equivalent instrument and the additional value combined for the selling value in response to the offering, and selling the monetary equivalent instrument and the additional value to the buyer for the selling value.

The compensation module 212 may be configured to compensate the issuing party for providing the additional value.

It will be understood that the purchase value, the selling value and the additional value may be determined based on the market factors or any other factors influencing the values.

The payments may be made via mail, bank transfer, check, eCheck, money order, credit card, electronic fund transfer, mobile wallet system, and so forth.

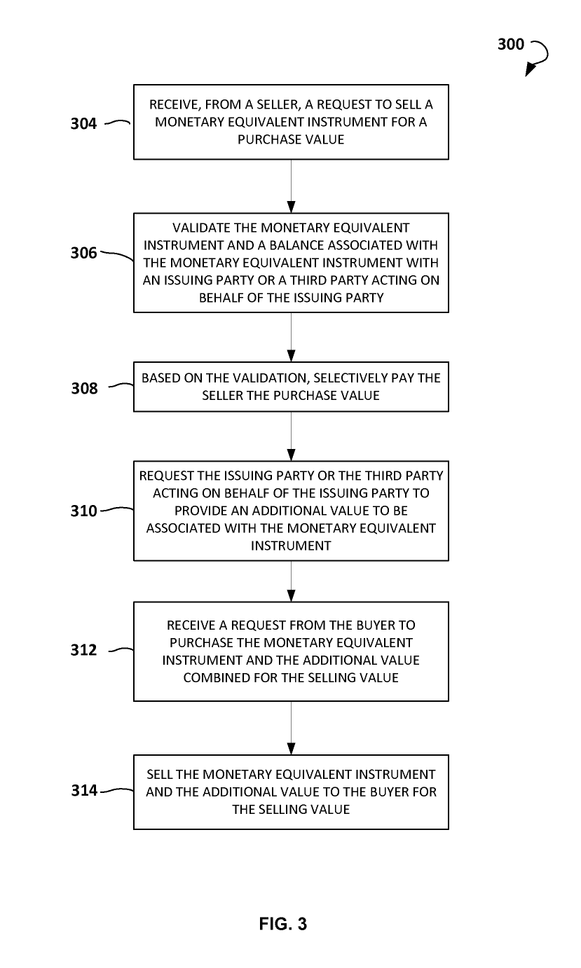

FIG. 3 is a process flow diagram showing a method 300 for trading in monetary equivalent instruments, according to an example embodiment. The method 300 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the trading system 200, and the method 300 may be performed by the various modules of the system 200. Each of these modules may comprise processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of various steps described herein, fewer or more modules may be provided and still fall within the scope of various embodiments.

As shown in FIG. 3, the method 300 may commence at operation 304 with the buying module 202 receiving, from a seller, a request to sell a monetary equivalent instrument for a purchase value. The purchase value may be less than a balance associated with the monetary equivalent instrument.

In one example embodiment, the purchase value may equal or be greater than the balance associated with the monetary equivalent instrument and the value added to the gift card may differ from the value added to the selling price of the card. For example, the trading system may purchase from a seller a $50 gift card for $60 and add $50 to the value of the gift card and $30 to the resale price. The trading system may than sell the $100 gift card for $90 and compensate the issuing party for the difference of $30.

Alternatively, the buyer may make a request to purchase the monetary equivalent instrument at the beginning of the method 300. For example, a buyer may request to purchase a $70 Wal-Mart gift card for $60. In response, the trading system 200 may search for a seller willing to sell a Wal-Mart gift card. If, for example, a seller willing to sell a $50 Wal-Mart gift card for $40 is found, the trading system 200 may add $20 to the $50 Wal-Mart gift card value and to a purchase price $40 and sell a $70 Wal-Mart gift card to the buyer for $60.

At operation 306, the validation module 204 may validate the monetary equivalent instrument and the balance associated with the monetary equivalent instrument with the issuing party. The seller may provide a redemption code and a pin number of the monetary equivalent instrument in order to verify the balance. The seller may also provide his phone ID, typically, this would be his phone number, to verify the balance.

At operation 308, based on the validation performed by the validation module 204, the payment module 206 may selectively pay the seller the purchase value. In some other embodiments, the payment module 206 may selectively pay the seller the purchase value later (e.g., after the buyer buys the monetary equivalent instrument and the additional value as will be described below with reference to operation 314).

At operation 310, the additional value module 208 may request the issuing party to provide an additional value to be associated with the monetary equivalent instrument. In a first example embodiment, the additional value may be provided by increasing the balance of the monetary equivalent instrument before the monetary equivalent instrument is sold to the buyer. In a second example embodiment, the additional value may be provided by deactivating the monetary equivalent instrument and issuing a new monetary equivalent instrument having a higher redemption value than the existing monetary equivalent instrument. In a third example embodiment, the additional value may be provided by packaging the monetary equivalent instrument with a further monetary equivalent instrument. In a fourth example embodiment, the additional value may be provided by splitting the monetary equivalent instrument into two or more new monetary equivalent instruments and increasing the balances of the new monetary equivalent instruments before they are sold to the buyer.

At operation 312, the sale module 210 may receive a request from the buyer to purchase the monetary equivalent instrument and the additional value combined for the selling value. Thereafter, at operation 314, the sale module 210 may sell the monetary equivalent instrument and the additional value to the buyer for the selling value. The monetary equivalent instrument and the additional value may be provided to the buyer by e-mail, wallet system, mail, electronic code, and/or other current and future technologies.

At operation 318, the compensation module 212 may compensate the issuing party 120 for providing the additional value. The compensation of the issuing party 120 can be the face value of the additional value or less than the face value.

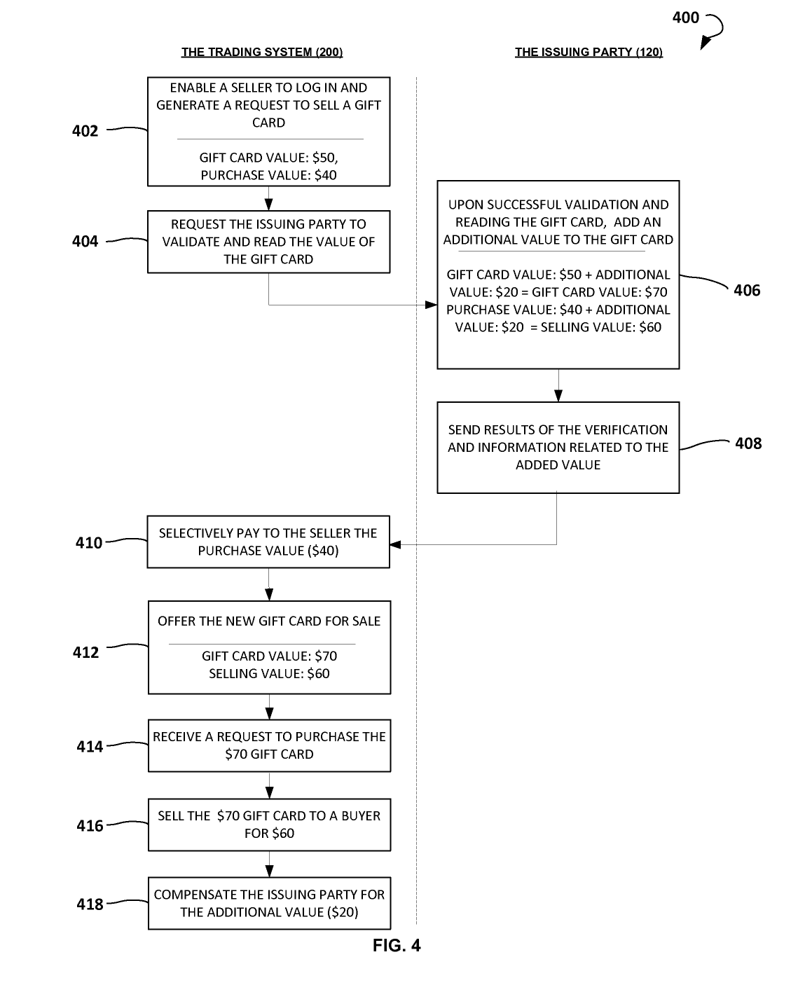

FIG. 4 is a process flow diagram showing a method 400 for trading in monetary equivalent instruments, wherein an additional value provided by an issuing party includes increasing the value of the existing monetary equivalent instruments before they are resold to the buyer, according to another example embodiment.

For example, a seller is willing to sell a $50 gift card in exchange for $40. However, the seller may not wish utilize a third party broker requiring the seller to mail the gift card because it will result in additional expenses. Additionally, the seller may not want to pay the higher third party broker fees.

Accordingly, the method 400 may commence at operation 402 with the trading system 200 enabling the seller to log in using the user interface 240 and sell the gift card in real time. There may be some broker fees involved as the seller, buyer, and/or the issuing party may be requested to pay to facilitate sales of the gift card and additional value.

Once the gift card is successfully validated and the card value is read via the issuing party 120, the issuing party 120 may add an additional value to the gift card according to predetermined settings at operation 406. To this end, the issuing party 120 is provided with an incentive to generate additional revenue.

For example, the issuing party 120 may add $20 to the value of the gift card (having a $50 face value) and to the selling price of the gift card ($40 value). This approach will result in the card having $70 value with a selling price of $60.

At operation 408, the issuing party 120 may send a response to the trading system 200. The response may comprise one or more of verification results, information related to the additional value, and the new value of the gift card.

At operation 410, upon receipt of the response, the trading system 200 may selectively pay the purchase value (i.e., $40) to the seller. In some other embodiments, the seller may be paid at operation 418, when the trading system 200 receives payment for the card from the buyer.

At operation 412, the trading system 200 may offer for sale the new $70 gift card. The selling value may be fixed to a lesser value, for example, $60. At operation 414, the trading system 200 may receive a request from a buyer to purchase the $70 gift card for the aforementioned $60. At the next operation 416, the trading system 200 may sell the $70 gift card to the buyer for $60.

At the final operation 418, the trading system 200 may compensate the issuing party 120 for the additional value (i.e., $20). Accordingly, when the buyer purchases the gift card, the buyer gets a $70 gift card at a $10 discount, the issuing party makes revenue of $20 for adding value to the card, and the seller gets $40 for the card. It will be understood that these values may change because a broker fee may be subtracted from the value due to the issuing party, buyer, seller, or any combination thereof.

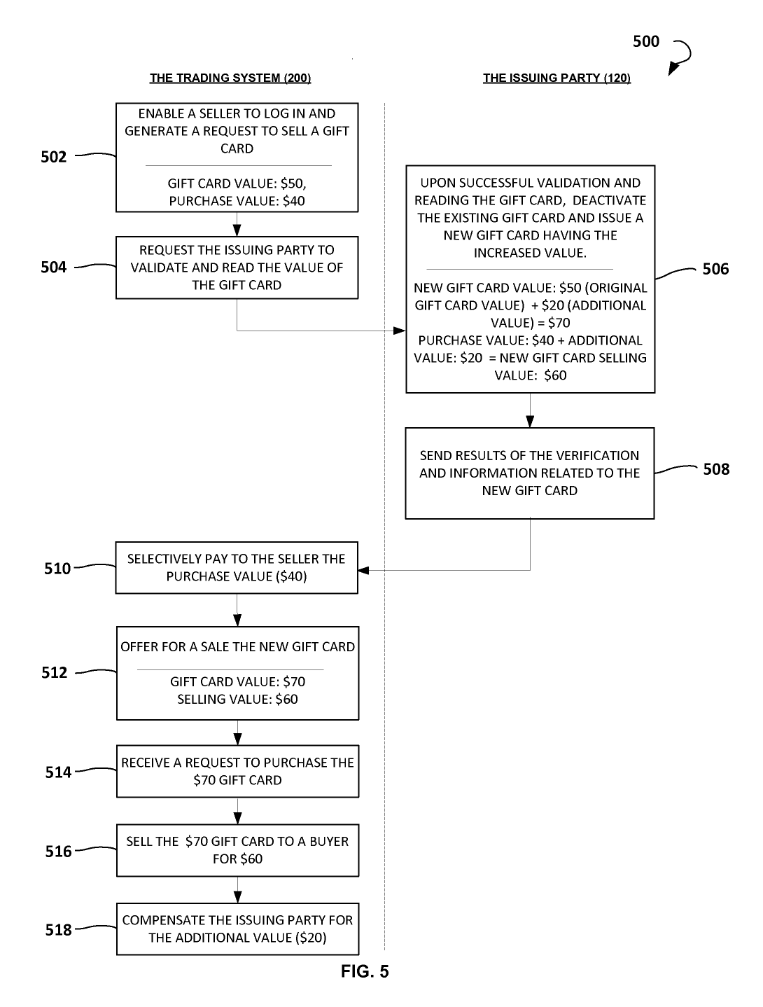

FIG. 5 a process flow diagram showing a method 500 for trading in monetary equivalent instruments, wherein an additional value provided by an issuing party includes deactivating the original monetary equivalent instrument and reissuing a new instrument having a higher redemption value, according to another example embodiment. The method 500 is similar to the method 400 described above with reference to FIG. 4. However, instead of adding value to the existing card, the issuing party 120 issues an entirely new card with the face value of $70.

More specifically, the method 500 may commence at operation 502 with the trading system 200 enabling the seller to log in using the user interface 240 and sell the gift card in real time. There may be some broker fees involved, and the seller may be requested to pay. In some embodiments, the broker fees may be paid by a buyer or by the issuing party for assisting with selling additional value.

At operation 504, the trading system 200 may request that the issuing party 120 validate and read the value of the gift card instantly. Once the gift card is successfully validated and the card value is read via the issuing party 120, the issuing party 120 may deactivate the gift card at operation 506, and issue a new gift card having the increased value according to predetermined settings. For example, the issuing party 120 may issue the new card having the same value as it was for the initial gift card ($50) and add an additional value of $20. Therefore, the value of the new gift card is $70.

It should be understood that additional value added to the gift card value and the additional value added to the purchase value does not have to be the same, it can be different. For example, $50 gift card value can be sold for $40. Additional value added to the gift card value $50+additional value $50=$100 gift card value. However, the additional value added to the purchase value can be different, for example $40 purchase value+$30 additional value=$70 Gift Card Selling Value. Thus, the additional values added can be different for the gift card value and the purchase price.

At operation 508, the issuing party 120 may send a response to the trading system 200. The response may comprise one or more of verification results and information related to the new gift card. At operation 510, upon receipt of the response, the trading system 200 may selectively pay to the seller the purchase value (i.e. $40). In some other embodiments, the seller may be paid at operation 518, when the trading system 200 receives payment for the new card from the buyer.

At operation 512, the trading system 200 may offer the new $70 gift card for sale. The selling value may be fixed to $60. At operation 514, the trading system 200 may receive a request from a buyer to purchase the $70 gift card. At the next operation 516, the trading system 200 may sell the $70 gift card to the buyer for $60.

At the final operation 518, the trading system 200 may compensate the issuing party 120 for the additional value (i.e. $20) added to the card. Accordingly, when the buyer purchases the gift card, the buyer gets a $70 gift card at a $10 discount, the issuing party makes revenue of $20 for adding value and reissuing a new card, and the seller gets $40 for the card. It will be understood that a small broker fee may be subtracted from the values due to the issuing party, buyer, seller, or any combination thereof.

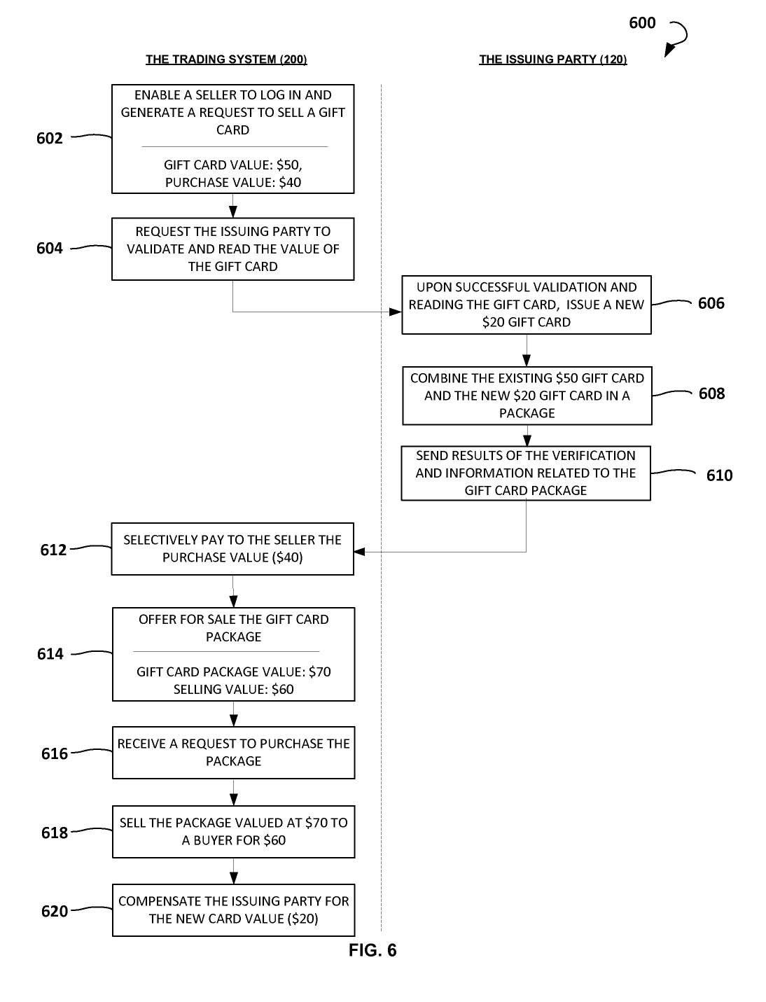

FIG. 6 is a process flow diagram showing a method 600 for trading in monetary equivalent instruments, wherein an additional value provided by an issuing party includes packaging the existing monetary equivalent instrument with other monetary equivalent instruments and selling the package, according to another example embodiment. The method 600 is similar to the methods 400 and 500 described above with references to FIGS. 4 and 5, respectively. However, instead of adding more value to the existing card or issuing an entirely new card, the issuing party 120 may package a newly issued gift card with the old gift card.

More specifically, the method 600 may commence at operation 602 with the trading system 200 enabling the seller to log in using the user interface 240 and sell, for example, a $50 gift card in real time. There may be some broker fees involved, and the seller, buyer, and/or the issuing party may be requested to pay to facilitate sales of the gift cards and additional values.

At operation 604, the trading system 200 requests that the issuing party 120 validate and read the value of the gift card instantly. At operation 606, once the gift card is successfully validated and the card value is read via the issuing party 120, the issuing party 120 may issue a new gift card having the additional value according to predetermined settings. For example, the issuing party 120 may issue the new card having the additional value of $20. At operation 608, the issuing party 120 may package the existing $50 gift card and the new $20 gift card in a package valued at $70.

At operation 610, the issuing party 120 may send a response to the trading system 200. The response may comprise one or more of verification results, information on the new gift card, and information related to the combination of the two cards. At operation 612, upon receipt of the response, the trading system 200 may selectively pay the purchase value (i.e., $40) to the seller. In some other embodiments, the seller may be paid at operation 620, when the trading system 200 receives payment for the package from the buyer.

At operation 614, the trading system 200 may offer the package of two gift cards valued at $70 for sale. However, the selling value may be fixed to a lesser value, for example, $60. At operation 616, the trading system 200 may receive a request from a buyer to purchase the $70 package. At operation 618, the trading system 200 may sell the $70 package to the buyer for $60. The package of two gift cards does not have to come from the same issuing party. Cards can be combined from different issuing parties, for example, a retailer, a merchant, a financial institution, and a credit card company.

At operation 620, the trading system 200 may compensate the issuing party 120 for the value of the new card (i.e., $20). Accordingly, when the package is purchased by the buyer, the buyer gets the $70 package of two gift cards at a $10 discount, the issuing party makes revenue of $20, and the seller gets $40 for the card. It will be understood that a small broker fee may be subtracted from the values due to the issuing party, buyer, seller, or any combination thereof.

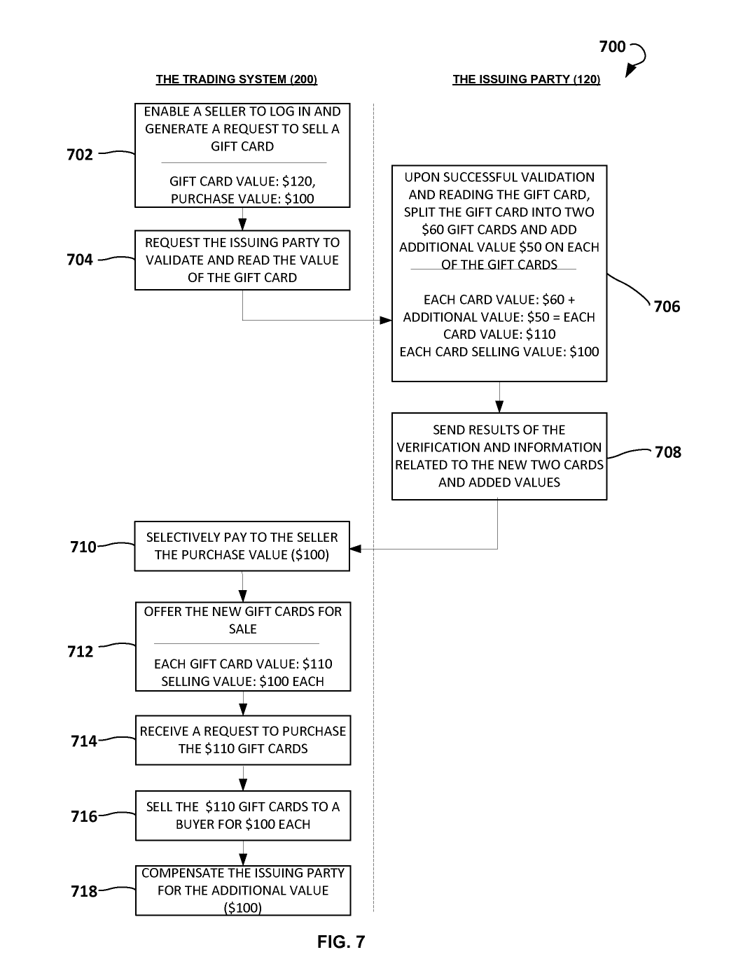

FIG. 7 is a process flow diagram showing a method 700 for trading in monetary equivalent instruments, wherein an additional value provided by an issuing party includes splitting a monetary equivalent instrument into two or more new monetary equivalent instruments and increasing the balances of the new monetary equivalent instruments before they are resold to a buyer, according to another example embodiment.

More specifically, the method 700 may commence at operation 702 with the trading system 200 enabling the seller to log in using the user interface 240 and sell the gift card in real time. There may be some broker fees involved, and the seller, buyer, and/or the issuing party may be requested to pay to facilitate sales of the gift cards and additional values.

At operation 704, the trading system 200 requests that the issuing party 120 validate and read the value of the gift card instantly. At operation 706, once the gift card is successfully validated and the card value is read via the issuing party 120, the issuing party 120 may split the gift card into two gift cards and add additional values to each of the gift cards according to predetermined settings. For example, the issuing party 120 may split the $120 gift card being sold for $100 into two $60 gift cards and add $50 to each of the cards (having a $60 face value) and to the selling value of the gift cards ($50 each). This approach will result in the two cards having $110 value each with a selling value of $100 each.

It will be understood that the above example is provided solely for illustrative purposes and that the card may be split into two or more cards with different balances.

At operation 708, the issuing party 120 may send a response to the trading system 200. The response may comprise one or more of verification results, information related to the additional values, and the new values of the gift cards.

At operation 710, upon receipt of the response, the trading system 200 may selectively pay the purchase value (e.g., $100) to the seller. In some other embodiments, the seller may be paid at operation 716, when the trading system 200 receives payment for the new cards from the buyer.

At operation 712, the trading system 200 may offer the two $110 gift cards for sale. The selling value may be fixed at $100 for each card. At operation 714, the trading system 200 may receive a request from one or more buyers to purchase the $110 gift cards each for the aforementioned $100. At the next operation 716, the trading system 200 may sell the $110 gift cards to the buyer or buyers for $100 each.

At the final operation 718, the trading system 200 may compensate the issuing party 120 for the additional values ($50 for each card). Accordingly, when the buyer purchases the gift card, the buyer may get a $110 gift card at a $10 discount, the issuing party makes revenue of $100 for adding value to the two cards, and the seller gets $100 for the card. It will be understood that these values may change because a broker fee may be subtracted from the value due to the issuing party, buyer, seller, or any combination thereof.

According to one example embodiment, the issuing party may first add the additional value to the gift card and then split it into two or more new cards. For example, a seller may be willing to sell a $100 gift card for $90. The issuing party may add an additional value of $60 to the $100 gift card and split the card into two $80 gift cards.

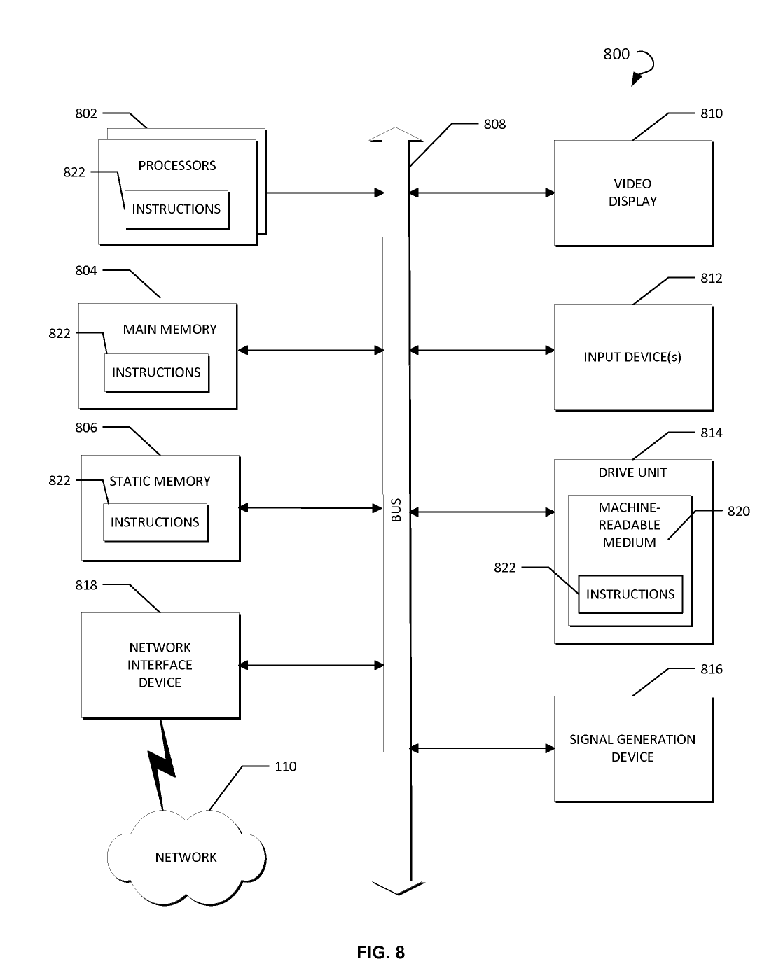

FIG. 8 shows a diagrammatic representation of a computing device for a machine in the example electronic form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a touch screen device, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), and a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes at least one input device 812, such as an alphanumeric input device (e.g., a keyboard), a cursor control device (e.g., a mouse), a microphone, and so forth. The computer system 800 also includes a disk drive unit 814, a signal generation device 816 (e.g., a speaker), and a network interface device 818.

The disk drive unit 814 includes a computer-readable medium 820, which stores one or more sets of instructions and data structures (e.g., instructions 822) embodying or utilized by any one or more of the methodologies or functions described herein. The instructions 822 may also reside, completely or at least partially, within the main memory 804 and/or within the processors 802 during execution thereof by the computer system 800. The main memory 804 and the processors 802 also constitute machine-readable media

The instructions 822 may further be transmitted or received over the network 110 via the network interface device 818 utilizing any one of a number of well-known transfer protocols (e.g., Hyper Text Transfer Protocol (HTTP), CAN, Serial, and Modbus).

While the computer-readable medium 820 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media may also include, without limitation, hard disks, floppy disks, flash memory cards, digital video disks, random access memory (RAM), read only memory (ROM), and the like.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and for interfaces to a variety of operating systems. Although not limited thereto, computer software programs for implementing the present method may be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for trading in monetary equivalent instruments have been disclosed. Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

What I claim is:

1. A computer-implemented method for trading in monetary equivalent instruments, the method comprising:
receiving, from a seller, a request to sell a monetary equivalent instrument for a purchase value;
validating the monetary instrument and a balance associated with the monetary equivalent instrument with an issuing party or a third party acting on behalf of the issuing party;
based on the validation, selectively paying the seller the purchase value;
requesting the issuing party or the third party acting on behalf of the issuing party to provide an additional value to be associated with the monetary equivalent instrument;
receiving a request from a buyer to purchase the monetary equivalent instrument and the additional value combined for a selling value;
selling the monetary equivalent instrument and the additional value to the buyer for the selling value.

2. The computer-implemented method of claim 1, further comprising compensating the issuing party or the third party acting on behalf of the issuing party for providing the additional value.

3. The computer-implemented method of claim 1, wherein the monetary equivalent instrument includes one or more of the following: a gift card, a voucher, a prepaid card, a credit card, or any stored-value card.

4. The computer-implemented method of claim 1, wherein the monetary equivalent instrument and the additional value are provided to the buyer electronically or by mail.

5. The computer-implemented method of claim 1, wherein the seller provides a redemption code and a pin number of the monetary equivalent in order to verify the balance.

6. The computer-implemented method of claim 1, wherein the additional value is provided by increasing the balance of the monetary equivalent instrument before the monetary equivalent is sold to the buyer.

7. The computer-implemented method of claim 1, wherein the additional value is provided by deactivating the monetary equivalent instrument and issuing a new monetary equivalent instrument having a higher redemption value than the monetary equivalent instrument.

8. The computer-implemented method of claim 1, wherein the additional value is provided by packaging the monetary equivalent instrument with a further monetary equivalent.

9. The computer-implemented method of claim 1, wherein the additional value is provided by splitting the monetary equivalent instrument into two or more new monetary equivalent instruments and increasing the balances of the new monetary equivalent instruments before they are sold to the buyer.

10. A system for trading in monetary equivalent instruments, the system comprising:
a buying module to receive, from a seller, a request to sell a monetary equivalent instrument for a purchase value;
a validation module to validate the monetary equivalent instrument and a balance associated with the monetary equivalent instrument with an issuing party or a third party acting on behalf of the issuing party;
a payment module to selectively pay the seller the purchase value;
an additional value module to request the issuing party to provide an additional value to be associated with the monetary equivalent instrument;
a sale module to receive a request from a buyer to purchase the monetary equivalent instrument and the additional value combined for a selling value, and sell the monetary equivalent instrument and the additional value to the buyer for the selling value.

11. The system of claim 10, further comprising a compensation module to compensate the issuing party or the third party acting on behalf of the issuing party for providing the additional value.

12. The system of claim 10, wherein the monetary equivalent instrument includes one or more of the following: a gift card, a voucher, a prepaid card, a credit card, or any stored-value card.

13. The system of claim 10, wherein the monetary equivalent instrument and the additional value are provided to the buyer electronically or by mail.

14. The system of claim 10, wherein the seller provides a redemption code and a pin number of the monetary equivalent instrument in order to verify the balance.

15. The system of claim 10, wherein the additional value is provided by increasing the balance of the monetary equivalent instrument before the monetary equivalent is sold to the buyer.

16. The system of claim 10, wherein the additional value is provided by deactivating the monetary equivalent instrument and issuing a new monetary equivalent instrument having a higher redemption value than the monetary equivalent instrument.

17. The system of claim 10, wherein the additional value is provided by packaging the monetary equivalent with a further monetary equivalent.

18. The system of claim 10, wherein the additional value is provided by splitting the monetary equivalent instrument into two or more new monetary equivalent instruments and increasing the balances of the new monetary equivalent instruments before they are sold to the buyer.

19. A computer-readable medium having instructions stored thereon, which when executed by one or more computers, causes the one or more computers to:
receive, from a seller, a request to sell a monetary equivalent instrument for a purchase value;
validate the monetary instrument and a balance associated with the monetary equivalent instrument with an issuing party or a third party acting on behalf of the issuing party;
based on the validation, selectively pay the seller the purchase value;
request the issuing party or the third party acting on behalf of the issuing party to provide an additional value to be associated with the monetary equivalent instrument;
receive a request from a buyer to purchase the monetary equivalent instrument and the additional value combined for a selling value;
sell the monetary equivalent instrument and the additional value to the buyer for the selling value.
